(19) United States
(12) Patent Application Publication
(10) Pub. No.: US 2012/0040109 A1
(43) Pub. Date: Feb. 16, 2012

(54) PRODUCT AND METHOD FOR ENCAPSULATED FABRIC

(75) Inventors: Jamie A. Henderson, Temeccula, CA (US); Randy E. Meirowitz, San Diego, CA (US)

(73) Assignee: Nextec Applications, Inc., Greenwich, CT (US)

(21) Appl. No.: 12/857,401

(22) Filed: Aug. 16, 2010

(51) Int. Cl. B32B 3/26; B32B 3/00; B29C 65/08; B32B 37/02; B29C 65/14

(52) U.S. Cl. 428/12; 156/307.3; 156/275.5; 156/73.1; 428/162

(57) ABSTRACT

The present invention involves the production of a fabric having double-sided encapsulation and a film overlaid on each side. In some embodiments, the fabric is a composite article that possesses low or a lack of air permeability, is light in weight, is flexible, and can be sewn in one web. Applications for such composite articles can range from entertainment devices such as inflatable toys to emergency devices such as airbags, inflatable rafts, aircraft emergency escape slides, various safety gear, and jump cushions commonly used by firefighters.

### FIELD OF THE INVENTION

The present invention relates to fabrics, and more particularly, embodiments relate to products and methods for encapsulated fabrics.

### DESCRIPTION OF THE RELATED ART

Substrate composite articles having a plurality of layers, especially those used in emergency inflatable devices such as airbags, could be vastly improved if there were a method for reducing the air permeability of the composite article, while: (i) maintaining the malleability (i.e., flexibility) of the composite article, (ii) maintaining characteristics of the original substrate within the composite article, (iii) maintaining or improving strength and durability of the composite article, and (iv) reducing the overall weight of the composite article.

At this time, several methods for improving adhesion between layers are known and used. U.S. Pat. No. 6,342,280, issued on Jan. 29, 2002, and U.S. Pat. No. 6,416,613, issued Jul. 9, 2002, both of which are incorporated herein by reference in their entireties, describe several of these conventional methods, including surface modification techniques such as covalently binding a modifier to a surface of a substrate material, causing an association or entrapment of the modifying molecule (or part of the molecule) with the substrate material, and retaining a modifier using only adhesive and cohesive forces between the modifier to the substrate and the modifier to itself, respectively. The patents also describe the use of surface coatings, saturations or impregnations, layers of fibers and/or polymers, unique chemical compositions, and combinations of the foregoing. As an improvement to these adhesions methods, the patents discuss the use of a composite article (i.e., substrate, web, fabric) that is encapsulated once, and has a film applied to at least one side.

However, despite the existence of these and other methods for improving adhesion between layers, there still exists a need for a composite article that exhibits limited air permeability, malleability, and reduced overall weight. Such a composite article would be very useful in manufacturing such inflatable protection devices, especially those devices that would benefit from a reduction in deflation rate. Two-sided airbags is one example of such a device.

Airbags produced for side windows, door panels, and the knee areas, where the airbag must hold air pressure for an extended period of time so that the person is protected for the duration of, e.g., a roll over crash. Two-sided airbags are produced for such purposes. Typically, these two-sided airbags are produced from two nylon fabrics having a very tight weave. The two fabrics are woven together in a continuous roll, and then coated with a heavy layer of silicone coating on both sides of the fabric in order to seal the surface. Unfortunately, because of its tight weave and heavy layer of silicone, the fabric tends to be very heavy, leading to heavy airbags.

### BRIEF SUMMARY OF EMBODIMENTS OF THE INVENTION

According to various embodiments of the invention, products and methods are provided for fabrics having double-sided encapsulation and a film overlaid on each side. For some such products and methods, the fabric is a composite article that possesses low (or a lack of) air permeability, is light in weight, is flexible, and can be sewn in one web (i.e., one-piece woven fabric like those used in airbags). Applications for such composite articles can range from entertainment devices such as an inflatable toys to emergency devices such as airbags (e.g., front, side and curtain airbags for vehicles), inflatable rafts, aircraft emergency escape slides, various safety gear, and jump cushions (also known as inflatable rescue cushions) commonly used by firefighters.

With particular respect to air permeability, the composite article in accordance with some embodiments exhibits an air permeability that is reduced in comparison to those composite articles having single-sided encapsulation and/or a single side of film. In some embodiments, the low or lack of air permeability can be attributed to the encapsulated layer and the coated layer that exists on both sides of the composite article, thereby preventing any holes from opening in the fabric, even when the fabric is stretched. Hence, when composite articles in accordance with an embodiment are used to create devices such as airbags, such airbags once inflated would exhibit increased air retention over airbags made from conventional airbag fabrics. Airbags possessing such a quality would be well suited for airbags that must remain inflated and retain air pressure for extended periods of time during and/or after an accident. A side curtain airbag, for example, is one such airbag.

Some composite articles in accordance with embodiments of the present invention would also benefit from a reduction in weight in comparison to other fabrics having low or no air permeability. Continuing with the airbag application, an airbag made of such composite articles would be light and flexible, resulting in a lower overall weight in the airbag assembly.

In one embodiment, a composite article created by a method is provided, the method comprising the operations of: applying an uncured polymer composition exhibiting thixotropic characteristics onto a first side of a base substrate (i.e., web), wherein the base substrate comprises structural elements having interstitial spaces therebetween; shear thinning the uncured polymer composition to place a first thin layer of the uncured polymer composition into the interstitial spaces on the first side, thereby resulting in a single-sided encapsulated base substrate; applying the uncured polymer composition exhibiting thixotropic characteristics onto a second side of a base substrate; shear thinning the uncured polymer composition to place a second thin layer of the uncured polymer composition into the interstitial spaces of the second side, thereby resulting in a double-sided encapsulated base substrate; overlaying on the first side a first layer of polymer or thermoplastic composition which may exhibit thixotropic characteristics; pressuring the first layer of polymer or thermoplastic composition into the interstitial spaces of the first side; overlaying on the second side a second layer of polymer or thermoplastic composition which may exhibit thixotropic characteristics; pressuring the second layer of polymer or thermoplastic composition into the interstitial spaces of the second side; and at least partially curing the first and second thin layers of the uncured polymer composition, base substrate, and first and second layers of polymer or thermoplastic composition, thereby producing the composite article. As used herein the term thixotropic means liquid flow behavior in which the viscosity of a liquid is reduced by shear agitation or stirring so as to allow the placement of the liquid flow to form: (a) a thin film of a polymer composition encapsulating 55 the structural elements (i.e., the fibers or filaments) making up the web leaving at least some of the interstitial spaces open; (b) an internal layer of a polymer composition; or (c) some combination of the foregoing.

In some embodiments, most of the structural elements on the first and second sides are encapsulated while substantially all the interstitial spaces of the first side remain open. In further embodiments, (i) the operation of pressuring the first layer of polymer or thermoplastic composition into the interstitial spaces of the first side forms chemical surface interactions and mechanical interlocking bonds between the first thin layer of uncured polymer composition and the first layer of polymer or thermoplastic composition, and (ii) the operation of pressuring the second layer of polymer or thermoplastic composition into the interstitial spaces of the second side forms chemical surface interactions and mechanical interlocking bonds between the second thin layer of uncured polymer composition and the second layer of polymer or thermoplastic composition. In some embodiments, the multi-layer composite article is formed into a shape prior to the curing operation.

It should be noted that methods for shear thinning as employed in some embodiments of the present invention can include those methods described in the following patents and patent applications, which are incorporated herein by reference in their entireties: U.S. Pat. No. 6,071,602, issued on Jun. 6, 2000; U.S. Pat. No. 6,289,841, issued on Sep. 18, 2001; U.S. Pat. No. 6,129,978 issued on Oct. 10, 2000; U.S. Pat. No. 5,958;137, issued Sep. 28, 1999; U.S. Pat. No. 5,935,637, issued on Aug. 10, 1999; U.S. Pat. No. 5,874,164, issued Feb. 23, 1999; U.S. Pat. No. 5,869,172, issued on Feb. 9, 1999; U.S. Pat. No. 5,876,792, issued on Mar. 2, 1999; U.S. Pat. No. 5,698,303, issued Dec. 16, 1997; U.S. Pat. No. 5,418,051, issued May 23, 1995; U.S. Pat. No. 5,209,965, issued May 11, 1993; and U.S. Pat. No. 5,004,643, issued Apr. 2, 1991, Manipulation and alteration of the polymer composition and the web (i.e., substrate) according to the methods of the above incorporated patents and patent applications, produces a web that either: (1) has at least some of its structural elements encapsulated by the polymer composition while at least some of the interstitial spaces of the web are open; or (2) has an internal layer extending through the web; or (3) has both encapsulated structural elements and an internal layer of polymer composition.

Further, according to some embodiments of the present invention, a method for precision placement of thin polymeric films within substrates to achieve improved substrate performance may be conducted substantially without the use of solvents. A polymeric composition is applied onto the surface of a web by a variety of means. After the polymer is applied to the surface of the web, the polymer composition is immediately shear thinned to controllably and significantly reduce its viscosity and place it into selected places within the web. To assist in this process, the web may be distorted, typically by stretching at the location of the shear thinning. This distortion facilitates the entrance of the polymer composition into the web by creating a double or dual shear thinning. In the case of the web, the distortion is produced by the combination of the edge condition of the blade, the engineered shear thinnable polymer, the speed of the web, and the subsequent repositioning of the fibers and filaments after their immediate passage under the edge of the blade.

Additionally, controlled placement of a polymer composition within a base web or substrate may be performed by a basic embodiment of a machine in accordance with U.S. Pat. No. 5,876,792, issued on Mar. 2, 1999. The technique may involve an applicator to apply viscous polymer to the surface of the web, a pair of facilities for applying tension to a section of the web and a blade forced against the web in the section under tension. The web is pulled under tension past the blade, or, alternatively, the blade is moved relative to the web, and the forces generated by the blade cause the polymer composition to flow into the three-dimensional matrix of the web, and controllably be extracted out of the web leaving a thin film of polymer encapsulating selected fibers, or an internal layer of polymer, or both. Tension on the web is preferably released thereafter, and for purposes of some embodiments of the present invention, the web is left uncured for the subsequent application of a layer or film on each side of the web, as described herein.

Depending on the embodiments, the overlaying may comprise coating or laminating the first and second sides with the polymer or thermoplastic composition which may exhibit thixotropic characteristics. In some such embodiments, it may be a conventional coating and/or laminating technique, such as knife-over-air, knife-over-roll, roll coating, reverse roll coating, gap coating, extrusion coating and other techniques. For example, in one embodiment of the present invention, the overlay material is applied using a knife-over-roll apparatus and method as supplied by Mascoe Systems Corporation in Mauldin, S.C. In further embodiment, the overlay material is applied using an extrusion process where overlay material (e.g., resin) is extruded from a slot die at a high temperature directly onto the moving web, which is then passed through a nip comprising of one or more rollers.

In further embodiments, the overlaying may comprise using shear thinning equipment to overlay and pressure the first and second layers of polymer or thermoplastic composition into the interstitial spaces of the first and second sides.

Further, for some embodiments, when using a polymer for the first and second layers, the overlaying may comprise using a film forming material. In some such embodiments, the film forming material may be a polymeric film forming material or a silicone polymeric film forming material. In those embodiments where the base substrate is encapsulated using a silicone polymer, the film forming material may be a silicone polymer that is similar in composition to the encapsulating silicone polymer.

In various embodiments, the pressuring of the overlay into the interstitial spaces of the uncured, encapsulated base substrate can be provided by calendaring.

With respect to the uncured polymer composition, in some embodiments, the uncured polymer composition may be selected from the group of film forming polymers which contains (but is not limited to) silicones, polyurethanes, fluorosilicones, silicone-modified polyurethanes, acrylics, polytetrafluoroethylene (PTFE), PTFE-containing materials, neoprenes, high consistency rubbers (HCR), combinations thereof and the like.

With respect to the base substrate, in various embodiments, the base substrate may be selected from a group consisting of cotton, wool, silk, jute, linen, rayon, acetate, polyesters, polyethyleneterephthalate, polyamides, nylon, acrylics, olefins, aramids, azlons glasses, fiberglass, modacrylics, novoloids, nytrils, rayons, sarans, spandex, vinal, vinyon, foams, films, foamed sheets, natural leathers, split hydes, synthetic leathers, vinyl, urethane, filtration membranes, polysulfones, polyimides, nitrocellulose, cellulose acetate, cellulose, and regenerated cellulose, and combinations thereof.

With respect to the overlay material, in further embodiments, the overlay material may be selected from the group of film forming polymers which contains (but is not limited to) silicones, polyurethanes, fluorosilicones, silicone-modified polyurethanes, acrylics, polytetrafluoroethylene (PTFE), PTFE-containing materials, neoprenes, high consistency rubbers (HCR), and combinations thereof.

In some embodiments, the composite article is an inflatable article, such as a front-side airbag, a side airbag, a side-curtain airbag, an inflatable raft, an aircraft emergency escape slide, or a firefighting emergency cushion.

Yet further embodiments include methods for creating composites in accordance with various limitations recited above.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

Some of the figures included herein illustrate various embodiments of the invention from different viewing angles. Although the accompanying descriptive text may refer to such views as “top,” “bottom” or “side” views, such references are merely descriptive and do not imply or require that the invention be implemented or used in a particular spatial orientation unless explicitly stated otherwise.

FIG. 1 is a flow diagram illustrating an example method for creating a composite in accordance with one embodiment of the present invention.

FIG. 2 is a Scanning Electron Microscopy (SEM) image of one side of an example base substrate encapsulated in accordance with an embodiment of the present invention before application of a subsequent layer or film.

FIG. 3 illustrates the cross section of a composite article made by an example method in accordance with one embodiment of the present invention.

FIG. 4 is a diagram illustrating an example composite created in accordance with one embodiment of the present invention.

FIG. 5 is a Scanning Electron Microscopy (SEM) images of an example base substrates encapsulated on two sides in accordance with one embodiment of the present invention using different amounts of a polymer composition.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

The present invention is directed toward methods and products for fabrics having double-sided encapsulation and a film overlaid on each side. According to some embodiments, the fabric is created using an encapsulation process to place a thin layer of polymer composition into the interstitial spaces of both sides of the fabric, leaving the polymer composition uncured, coating both sides of the encapsulated fabric with a layer of polymer or thermoplastic composition, and curing the layer of polymer or thermoplastic composition, hereby bonding the polymer or thermoplastic composition to the initial encapsulated layer and resulting in a single layer that is tightly placed inside and on the surface of the fabric. This single layer on each side of the fabric functions as an excellent barrier to air, decreasing the fabric's overall air permeability. Hence, when such a fabric is used to create, for example, an airbag, and that airbag is subsequently inflated, the encapsulated layer and the coated layer on each side of the fabric operate in tandem as the fabric stretches, thereby preventing; any holes from opening in the fabric.

Further, due in part to the placement of the polymer into the fabric, and the bonding of the encapsulated polymer to the surface coated polymer or thermoplastic, the fabric does not need to be as tightly woven as conventional low air permeability fabrics and needs less polymer to cover the surface. As a result, the fabric possesses air permeability comparable to that of conventional fabrics using less polymer covering than conventional fabrics.

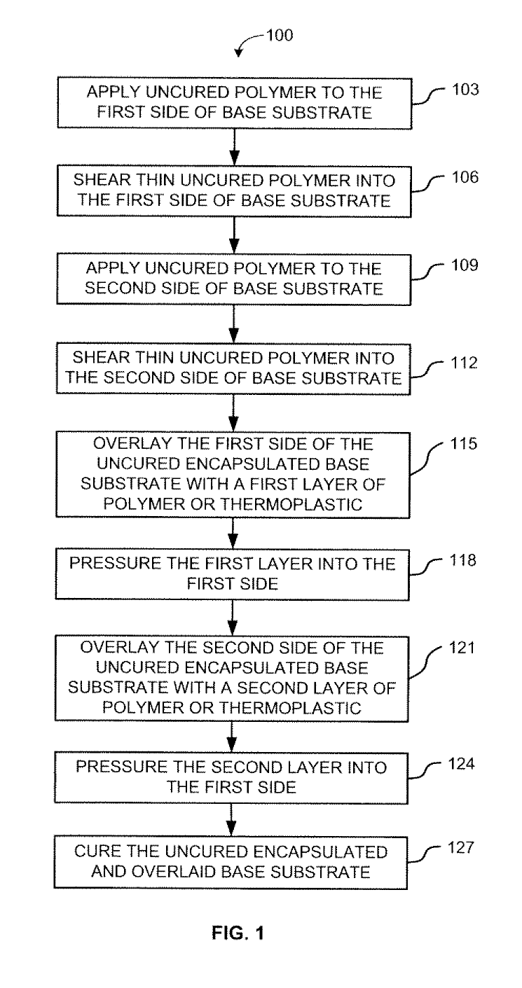

Referring now to the drawings, FIG. 1 is a flow diagram illustrating an example method 100 for creating a composite in accordance with one embodiment of the present invention. At operation 103, an uncured polymer composition is applied to a first side of a base substrate. Depending on the embodiment, the uncured polymer composition may be from the group of film forming polymers which may include (but is not limited to) silicones, polyurethanes, fluorosilicones, silicone-modified polyurethanes, acrylics, polytetrafluoroethylene (PTFE) PTFE-containing materials, neoprenes, high consistency rubbers (HCR), combinations thereof and the like. Further, the base substrate may be selected from a variety of material types, including cotton, wool, silk, jute, linen, rayon, acetate, polyesters, polyethyleneterephthalate, polyamides, nylon, acrylics, olefins, aramids, azlons, glasses, fiberglass, modacrylics, novoloids, nytrils, rayons, sarans, spandex, vinal, vinyon, foams, films, foamed sheets, natural leathers, split hydes, synthetic leathers, vinyl, urethane, filtration membranes, polysulfones, polyimides, nitrocellulose, cellulose acetate, cellulose, and regenerated cellulose, and combinations thereof.

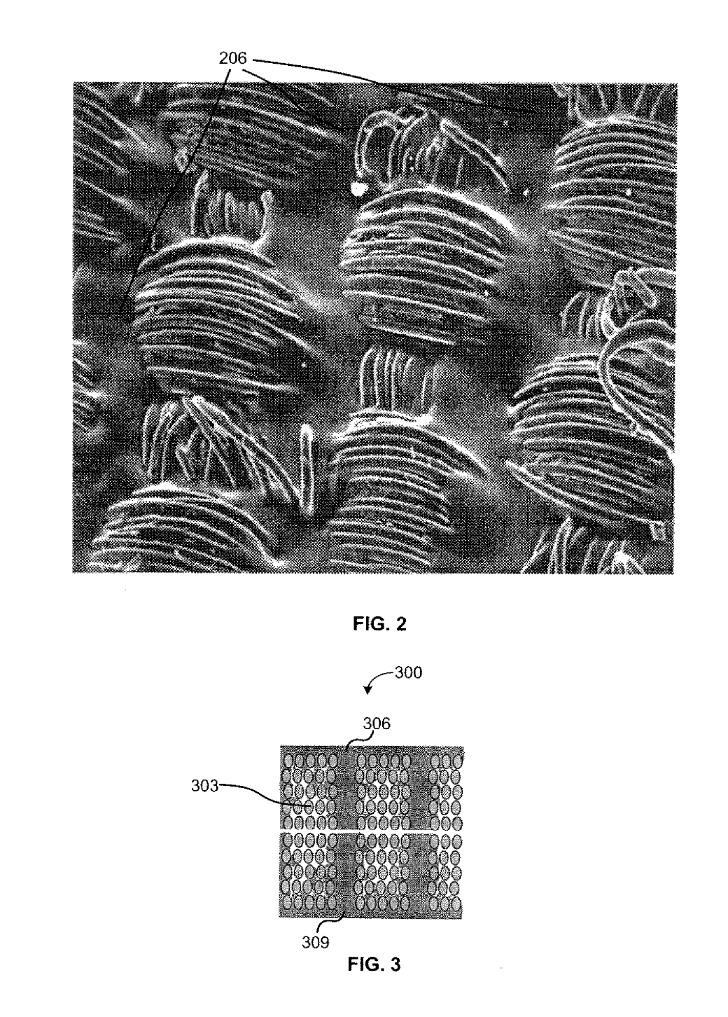

At operation 106, the uncured polymer composition is then shear thinned into the first side of base substrate, thereby causing the uncured composition to be placed into the interstitial spaces of the first side. As noted previously, the shear thinning causes a thin, internal layer of uncured polymer composition to extend through the first side of the substrate. FIG. 2 provides a Scanning Electron Micrograph (SEM) image of an example fibrous web (i.e., substrate) treated in accordance with such a shear thinning process. Referring now to FIG. 2, the base substrate of FIG. 2 shows an internal layer placed in the interstitial spaces between fiber bundles and encapsulated fibers within the bundles. Also depicted are the interstitial spaces 206 between fiber bundles that remain open.

FIG. 3 illustrates further details of a fibrous web treated in accordance with such a shear thinning process. Specifically, FIG. 3 illustrates the cross section of a composite article 300 made by an example method in accordance with one embodiment of the present invention. The composite article 300 as illustrated comprises an uncured polymer composition 306 and 309 extending through the first and second sides of the fibrous web 303.

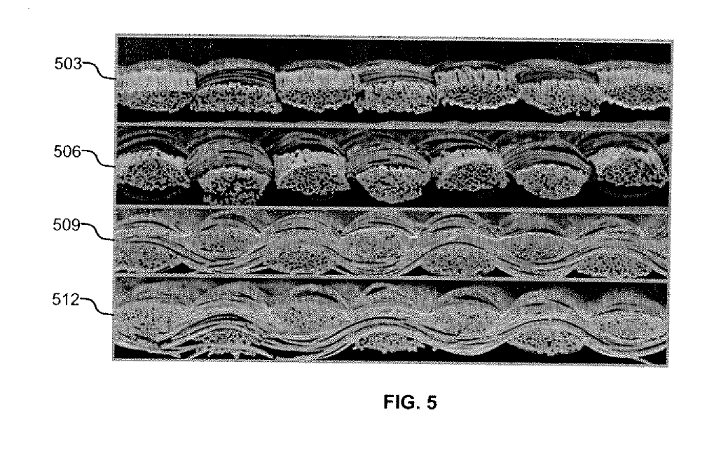

FIG. 5 depicts Scanning Electron Microscopy (SEM) images of example base substrates encapsulated on two sides in accordance with one embodiment of the present invention using different amounts of a polymer composition. Specifically, FIG. 5 depicts one-piece weave fabrics having silicon encapsulation at 5.58 ounces per square yard (503), 6.34 ounces per square yard (506), 6.66 ounces per square yard (509) and 6.29 ounces per square yard (512).

With further reference to FIG. 1, the shear thinning process encapsulates at least some of the structural elements of the first side, while at least some interstitial spaces of the base substrate open. With only some of the interstitial spaces open, as depicted in FIG. 2, the air permeability of the base substrate is limited yet not eliminated altogether. Alternatively, the structural elements of the base substrate may be encapsulated substantially completely such that the substrate is impermeable or substantially impermeable to air and other gases. Method 100 continues by applying 109 the uncured polymer composition one the second side of the base substrate and shear thinning 112 the uncured polymer composition into the second side of the base substrate, similar to the first side.

Next, during operation 115, an overlay material is applied to the first side of the uncured encapsulated base substrate as a first layer. Depending on the embodiment, the overlay material may be a polymer or a thermoplastic. For example, some overlay materials include but are in no way limited to, silicones, polyurethanes, fluorosilicones, silicone-modified polyurethanes, acrylics, polytetrafluoroethylene (PTFE), PTFE-containing materials, neoprenes, high consistency rubbers (HCR), and combinations thereof. Operation 118 involves pressuring the first layer of the overlay material into the first side. The pressuring of the overlay material causes chemical and mechanical interlocking bonds to form between the first side of the base substrate and the overlay material. Following operation 118, the overlay material is applied and pressured into the second side during operations 121 and 124. Again, the pressuring of the overlay material causes chemical and mechanical interlocking bonds to form between the second side of the base substrate and the overlay material.

Method 100 concludes with operation 127, where the uncured polymer composition, base substrate, and overlay material are cured. A variety of methods can be utilized during the curing process, including the application of thermal energy, electron beam radiation, microwave energy, electromagnetic radiation and/or ultrasonic energy.

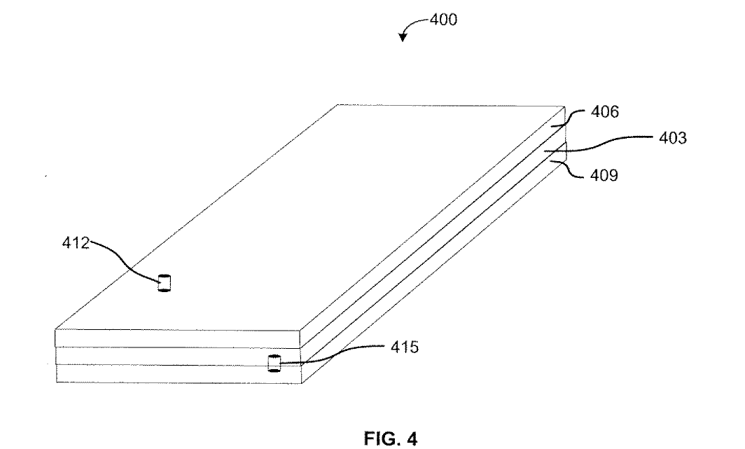

FIG. 4 is a diagram illustrating an example composite 400 created in accordance with one embodiment of the present invention. Referring now to FIG. 4, composite 400 comprises a dual-sided encapsulated base substrate 403, a first overlay material layer 406, and a second overlay material layer 409. Described another way, the basic unit of structure for composite 400 is 2 n films to n fabrics. One cause of air permeation through a film is the formation of pinholes during the casting of the film. However, in the configuration depicted, the issue of pinholes is mitigated because even if each layer forms a pinhole 412 and 415 there is a reduced chance of the pinholes lining up providing an air path all the way through both films than by a single pinhole providing an air path all the way through a single film layer is cast to 2 n thickness.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to impart the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A composite article created by a method comprising the operations of:
applying an uncured polymer composition exhibiting thixotropic characteristics onto a first side of a base substrate, wherein the base substrate comprises structural elements having interstitial spaces therebetween;
shear thinning the uncured polymer composition to place a first thin layer of the uncured polymer composition into the interstitial spaces on the first side, thereby resulting in a single-sided encapsulated base substrate wherein most of the structural elements on the first side are encapsulated while most of the interstitial spaces of the first side remain open;
applying the uncured polymer composition exhibiting thixotropic characteristics onto a second side of a base substrate;
shear thinning the uncured polymer composition to place a second thin layer of the uncured polymer composition into the interstitial spaces on the second side, thereby resulting in a double-sided encapsulated base substrate wherein most of the structural elements on the second side are encapsulated while most of the interstitial spaces of the second side remain open;
overlaying on the first side a first layer of polymer or thermoplastic composition which may exhibit thixotropic characteristics;
pressuring the first layer of polymer or thermoplastic composition into the interstitial spaces of the first side;
overlaying on the second side a second layer of polymer or thermoplastic composition which may exhibit thixotropic characteristic;
pressuring the second layer of polymer or thermoplastic composition into the interstitial spaces of the second side; and
at least partially curing the first and second thin layers of the uncured polymer composition, base substrate, and first and second layers of polymer or thermoplastic composition, thereby producing the composite article.

2. The composite article of claim 1, wherein pressuring the first layer of polymer or thermoplastic composition into the interstitial spaces of the first side forms chemical surface interactions and mechanical interlocking bonds between the first thin layer of uncured polymer composition and the first layer of polymer or thermoplastic composition.

3. The composite article of claim 1, wherein pressuring the second layer of polymer or thermoplastic composition into the interstitial spaces of the second side forms chemical surface interactions and mechanical interlocking bonds between the second thin layer of uncured polymer composition and the second layer of polymer or thermoplastic composition.

4. The composite article of claim 1, wherein overlaying comprises coating or laminating the first and second sides with the polymer or thermoplastic composition.

5. The composite article of claim 1, wherein overlaying and pressuring comprises using shear thinning equipment to overlay and pressure the first and second layers of polymer or thermoplastic composition into the interstitial spaces of the first and second sides.

6. The composite article of claim 1, wherein pressuring is achieved by calendaring.

7. The composite article of claim 1, wherein the first and second layers comprise a polymer, and wherein overlaying comprises using a film forming material.

8. The composite article of claim 7, wherein the film forming material is a polymeric film forming material.

9. The composite article of claim 7, wherein the film forming material is a silicone polymeric film forming material.

10. The composite article of claim 1, wherein the uncured polymer composition is selected from the group consisting of silicones, polyurethanes, fluorosilicones, silicone-modified polyurethanes, acrylics, mod acrylics, polytetrafluoroethylene (PTFE), PTFE-containing materials, neoprenes, high consistency rubbers (HCR), and combinations thereof.

11. The composite article of claim 1, wherein the base substrate is selected from the group consisting of cotton, wool, silk, jute, linen, rayon, acetate, polyesters, polyethyleneterephthalate, polyamides, nylon, acrylics, olefins, aramids, azlons, glasses, fiberglass, modacrylics, novoloids, nytrils, rayons, sarans, spandex, vinal, vinyon, foams, films, foamed sheets, natural leathers, split hydes, synthetic leathers, vinyl, urethane, filtration membranes, polysulfones, polyimides, nitrocellulose, cellulose acetate, cellulose, and regenerated cellulose, and combinations thereof.

12. The composite article of claim 1, wherein the polymer or thermoplastic composition is selected from the group consisting of silicones, polyurethanes, fluorosilicones silicone-modified polyurethanes, acrylics, mod acrylics, polytetrafluoroethylene (PTFE), PTFE-containing materials, neoprenes, high consistency rubbers (HCR), and combinations thereof.

13. The composite article of claim 1, wherein the composite article is an inflatable article.

14. The composite article of claim 12, wherein the inflatable article is a front-side airbag a side airbag, a side-curtain airbag, an inflatable raft, an aircraft emergency escape slide, firefighting emergency cushion, or recreational inflatable such as children's jumper.

15. The composite article of claim 1, wherein curing is provided by an energy source selected from the group consisting of thermal energy, electron beam radiation, microwave energy, electromagnetic radiation and ultrasonic energy.

16. The composite article of claim 2, wherein chemical surface interactions include Van der Waal forces, dipole/dipole interactions and/or Hydrogen bonding.

17. The composite article of claim 2, wherein mechanical interlocking bonds arise when the first and second layers of polymer or thermoplastic composition is pressed through the interstitial spaces left open after encapsulation.

18. A method of preparing a composite, comprising:
applying an uncured polymer composition exhibiting thixotropic characteristics onto a first side of a base substrate, wherein the base substrate comprises structural elements having interstitial spaces therebetween;
shear thinning the uncured polymer composition to place a first thin layer of the uncured polymer composition into the interstitial spaces on the first side, thereby resulting in a single-sided encapsulated base substrate wherein most of the structural elements on the first side are encapsulated while most of the interstitial spaces of the first side remain open;
applying the uncured polymer composition exhibiting thixotropic characteristics onto a second side of a base substrate;
shear thinning the uncured polymer composition to place a second thin layer of the uncured polymer composition into the interstitial spaces on the second side, thereby resulting in a double-sided encapsulated base substrate herein of the structural elements on the first side are encapsulated while most of the interstitial spaces of the second side remain open;
overlaying on the first side a first layer of polymer or thermoplastic composition which may exhibit thixotropic characteristics;
pressuring the first layer of polymer or thermoplastic composition into the interstitial spaces of the first side;
overlaying on the second side a second layer of polymer or thermoplastic composition which may exhibit thixotropic characteristics;
pressuring the second layer of polymer or thermoplastic composition into the interstitial spaces of the second side; and
at least partially curing the first and second thin layers of the uncured polymer composition, base substrate, and first and second layers of polymer or thermoplastic composition, thereby producing the composite.

19. The method of claim 18, wherein pressuring the first layer of polymer or thermoplastic composition into the interstitial spaces of the first side forms chemical surface interactions and mechanical interlocking bonds between the first thin layer of uncured polymer composition and the first layer of polymer or thermoplastic composition.

20. The method of claim 18, wherein pressuring the second layer of polymer or thermoplastic composition into the interstitial spaces of the second side forms chemical surface interactions and mechanical interlocking bonds between the second thin layer of uncured polymer composition and the second layer of polymer or thermoplastic composition.

21. The method of claim 18, wherein overlaying comprises coating or laminating the first and second sides with the polymer or thermoplastic composition.

22. The composite article of claim 18, wherein overlaying and pressuring comprises using shear thinning equipment to overlay and pressure the first and second layers of polymer or thermoplastic composition into the interstitial spaces of the first and second sides.

23. The method of claim 18, wherein pressuring is achieved by calendaring.

24. The method of claim 18, wherein the first and second layers comprise a polymer, and wherein overlaying comprises using a film forming material.

25. The method of claim 24, wherein the film forming material is a polymeric film forming material.

26. The method of claim 24, wherein the film farming material is a silicone polymeric film forming material.

27. The method of claim 18, wherein the uncured polymer composition is selected from the group consisting of silicones, polyurethanes, fluorosilicones, silicone-modified polyurethanes, acrylics, mod acrylics, polytetrafluoroethylene (PTFE), PTFE-containing materials, neoprenes, high consistency rubbers (HCR), and combinations thereof.

28. The method of claim 18, wherein the base substrate is selected from the group consisting of cotton, wool, silk, jute, linen, rayon, acetate, polyesters, polyethyleneterephthalate, polyamides, nylon, acrylics, olefins, aramids, azlons, glasses, fiberglass, modacrylics, novoloids, nytrils, rayons, sarans, spandex, vinyl, vinyon, foams, films, foamed sheets, natural leathers, split hydes, synthetic leathers, vinyl, urethane, filtration membranes, polysulfones, polyimides, nitrocellulose, cellulose acetate, cellulose, and regenerated cellulose, and combinations thereof.

29. The method of claim 17, wherein the polymer or thermoplastic composition is selected from the group consisting of silicones, polyurethanes, fluorosilicones, silicone-modified polyurethanes, acrylics, mod acrylic, polytetrafluoroethylene (PTFE), PTFE-containing materials, neoprenes, high consistency rubbers (HCR), and combinations thereof.

30. The method of claim 18, wherein the composite is an inflatable article.

31. The method of claim 30, wherein the inflatable article is a front-side airbag, a side airbag, a side-curtain airbag, an inflatable raft, an aircraft emergency escape slide, or a firefighting emergency cushion, or recreational inflatable such as children's jumper.

32. The method article of claim 18, wherein curing is provided by an energy source selected from the group consisting of thermal energy, electron beam radiation, microwave energy, electromagnetic radiation and ultrasonic energy.

33. The method article of claim 19, wherein chemical surface interactions include Van der Waal, forces dipole/dipole interactions and/or Hydrogen bonding.

34. The method article of claim 19, wherein mechanical interlocking bonds arise when the first and second layers of polymer or thermoplastic composition is pressed through the interstitial spaces left open after encapsulation.
